(19) United States
(12) Patent Application Publication
(10) Pub. No.: US 2010/0084382 A1
(43) Pub. Date: Apr. 8, 2010

(54) LASER MICROMACHINING SYSTEM IN-LINE WITH A STAMPING PRESS

(75) Inventor: Denis Julien Gendron, Kitchner (CA)

Correspondence Address: SMART & BIGGAR, 438 UNIVERSITY AVENUE, SUITE 1500, BOX 111, TORONTO, ON, M5G 2K8, CA

(73) Assignee: Claire Lasers Corporation, Kitchner, Ontario (CA)

(21) Appl. No.: 12/519,074

(22) PCT Filed: Dec. 12, 2007
(86) PCT No.: PCT/CA2007/002225

§ 371 Date: Jun. 12, 2009

Related U.S. Application Data
(60) Provisional application No. 60/869,563, filed on Dec. 12, 2006.

(51) Int. Cl. B23K 26/04; B23K 26/00

(52) U.S. Cl. 219/121.62; 219/121.85

(57) ABSTRACT

A first portion of a continuous material strip is indexed through a stamping press and the stamping press is cycled so as to undertake a stamping operation on a section of the material strip during each cycle. A length of the continuous strip is accumulated in an accumulator either upstream or downstream of the stamping press. A second portion of the strip is continuously fed at a non-zero speed through a laser micromachining station positioned such that the accumulator is between the stamping press and the laser micromachining station. The speed of the second portion of said strip is controlled so that this speed is constant for at least a portion of each cycle of the stamping press and so that the average speed of the first portion of said strip through the stamping press is equal to the average speed of the second portion of the strip through the laser micromachining station. A laser of the laser micromachining station irradiates the second portion of the strip while the speed of the second portion of said strip is constant. The timing of the laser processing event within the cycle of the stamping press may be such that the laser processing event occurs at a time when the ram of the stamping press is furthest away from actual material stamping event in order to avoid the deleterious effects of stamping vibration on the laser processing quality and reliability of the laser micromachining system.

### BACKGROUND

This invention relates to laser micromachining of a continuous material strip in-line with a stamping press.

Laser micromachining encompasses processes such as laser marking, laser cutting, laser milling or laser ablation of material, typically effected with a high quality laser beam, as, for example, a beam with a characteristic M² value smaller than 3 to 5, and, indeed, ideally, with an M² value smaller than 1.5.

The material of the continuous strip is typically metal, but may be any material that can be processed as a strip in a stamping press.

A stamping press is commonly used to rapidly form, punch, and/or shear cut identical metal parts in large quantities. Where the only process required is shear cutting, the ram of the press is typically provided with a simple blanking die. On the other hand, where a series of forming operations are needed to complete the metal part, the ram of the stamping press is typically provided with a progressive die. In either instance, a continuous metal strip is fed to the stamping press and indexed forward during each cycle of the stamping press. In consequence, if a given section of the metal strip is in-line with the first die section of a progressive die in a first cycle of the stamping press, this section of the metal strip is partly formed by the first die section. Thereafter, this section is indexed forward to be in-line with the second die section so that it may be further formed by the second die section, and so on. At the last die section of the progressive die, the fully formed metal part might be sheared from the metal strip, or it could be left in place in the strip to allow for subsequent operations. Margins of the strip are left in place by the dies so that these margins may be used to feed the strip.

While a stamping press can undertake many different material forming operations, there are other operations which it is not capable of undertaking or for which it is not suitable. For example, a press cannot be used to form different small indented or marked features on each part, such as a part number or other part specific identification mark, as it is not realistic to change out a die section so frequently. Thus, operations such as the marking of a part number or date code on parts is commonly done as a separate operation, and in many instances manually, which adds significantly to the cost of the finished parts.

It is known in, for example, U.S. Pat. No. 6,479,787 to Jendick, to place a laser in-line with a stamping press to undertake certain of these other operations. In the known arrangement on Jendick, the laser is operated during the part of each cycle of the stamping press when stamping is occurring, since that is the part of the cycle when the metal strip is stopped.

A stamping die can cycle 100 to 600 times per minute. Thus, the cycle time is 100 to 600 ms. During this time, the material strip is accelerated, decelerated and stopped to allow stamping. The dwell time during which the material strip is stopped is, at best, about ⅙ to ⅛ of the press cycle, which corresponds approximately to a dwell time of between 15 and 100 ms. Such a short dwell time generally requires a very powerful pulsed laser (Q-switched or mode locked, with an average power of 50 to 200 Watts, and a peak pulse power of 5 to 100 kWatts) in order to complete desired laser operations in the time available.

A further drawback with this arrangement is that the vibrations set up by the ram while stamping can alter the precision of the deflection mechanism steering the laser beam thereby negatively impacting on the quality of laser processing.

This invention seeks to improve systems using a laser in-line with a stamping press.

### SUMMARY OF INVENTION

The temporal speed profile of a continuous strip of material operated on by a stamping press is controlled past a laser so that the strip has a constant speed during laser micromachining.

In one aspect, there is provided a method for processing a continuous material strip which comprises indexing a first portion of the continuous material strip through a stamping press and cycling the stamping press so as to undertake a stamping operation on a section of said material strip during each cycle of said stamping press. A length of the continuous strip is accumulated in an accumulator either upstream or downstream of the stamping press. A second portion of the strip is continuously fed at a non-zero speed through a laser micromachining station positioned such that the accumulator is between the stamping press and the laser micromachining station. The speed of the second portion of the strip through the laser micromachining station is controlled so that it is constant for at least a portion of each cycle of the stamping press and so that an average speed of the first portion of the strip through the stamping press is equal to an average speed of the second portion of the strip through the laser micromachining station. A laser micromachining operation is undertaken on the second portion of the strip while the speed of the second portion of the strip is constant.

In another aspect, a laser micromachining system for use in-line with a stamping press operating on a continuous material strip comprises a scanning laser; a feeder for feeding the material strip past the scanning laser; and control means input by a cycle indicating signal indicating each cycle of the stamping press and a signal indicating material progression through the press and outputting to a control input of the feeder and an input of the scanning laser. The control means is for determining an average speed of the material strip through the stamping press; determining a speed profile for the material strip past the scanning laser based on the average speed; and controlling the feeder and the laser based on the speed profile.

In a further aspect, an in-line continuous material strip stamping and laser micromachining system comprises a stamping press for indexing downstream and stamping a first portion of a continuous material strip during each of consecutive cycles; an accumulator either upstream or downstream of the stamping press for accumulating a length of the continuous material strip; a laser micromachining station for undertaking a laser micromachining operation on the second portion of the strip, the laser micromachining station positioned such that the accumulator is between the stamping press and the laser micromachining station; control means for controlling the speed of the second portion of the strip so that the speed is constant for at least a portion of each cycle of the stamping press and so that an average speed of the first portion of the strip through the stamping press is equal to an average speed of a second portion of the strip through the laser micromachining station and for triggering the laser micromachining station to undertake the laser micromachining operation while the speed of the second portion of the strip is constant.

Other features and advantages will become apparent from a review of the following detailed description in conjunction with the drawings.

### BRIEF DESCRIPTION OF THE DRAWINGS

In the figures which illustrate example embodiments of the invention,

FIG. 1 is a schematic side view of a system implementation illustrating a typical application of this invention,

FIG. 2 is a schematic detail view of the laser station of FIG. 1,

FIG. 3 is a schematic view showing electrical interconnection of certain active components of the system of FIGS. 1 and 2,

FIG. 4 is a series of schematic diagrams illustrating the origin of the vibration noise in a press system,

FIGS. 5 to 7 are graphs illustrating modes of operation of the system of FIG. 1 and known systems, and

FIG. 8 is a block diagram illustrating aspects of the operation of the system of FIGS. 1 and 2.

### DETAILED DESCRIPTION

In overview, an accumulator is positioned between an in-line laser micromachining station and a stamping press. The average speed of a continuous material strip through both the press and the laser station is kept identical, but the instantaneous speeds are allowed to differ. A length of the continuous strip is accumulated in the accumulator to deal with these instantaneous differences between these two speeds.

The optimal speed of material through the laser station may have two components: (i) a constant component with a magnitude dictated by the trade off between the laser micromachining time and press cycle motion requirements followed by (ii) a pulsed component with a pulse profile and magnitude dictated by conservation of the material strip length in the accumulator over the cycle time, and the practical limits for the acceleration and deceleration of the continuous material strip by the material feeder. The laser micromachining occurs during the first component, while the speed of the material strip is constant (or nearly constant). The actual micromachining time is therefore dynamic due to variations in material speed through the press, and due to changes in the micromachining operation. Ideally, the constant speed component occurs when the press ram is close to its top dead center so as to effect laser micromachining during the quietest part of the ram cycle (i.e., when mechanical vibrations from press stamping are at a minimum).

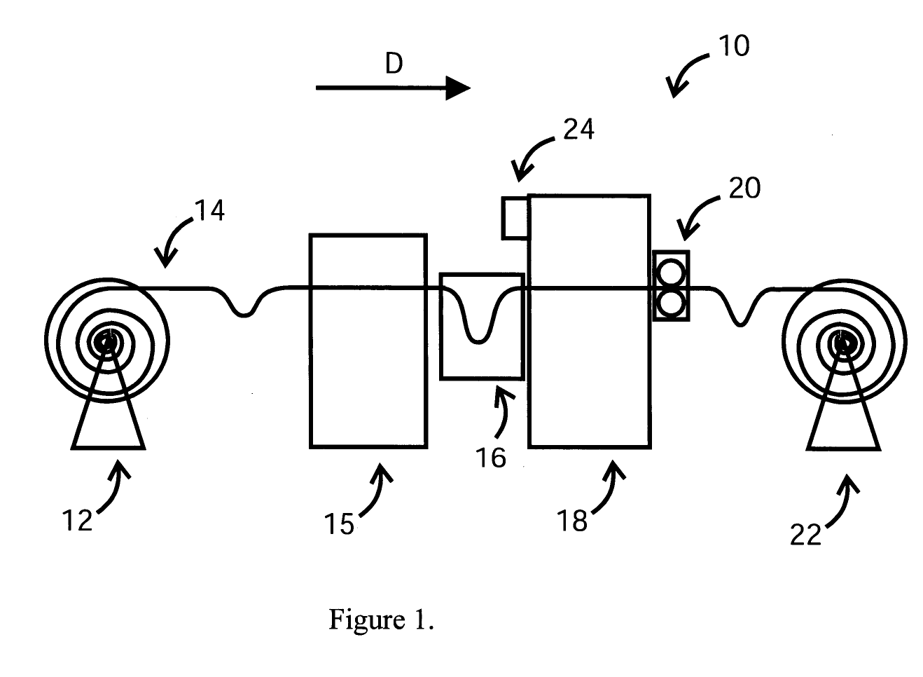

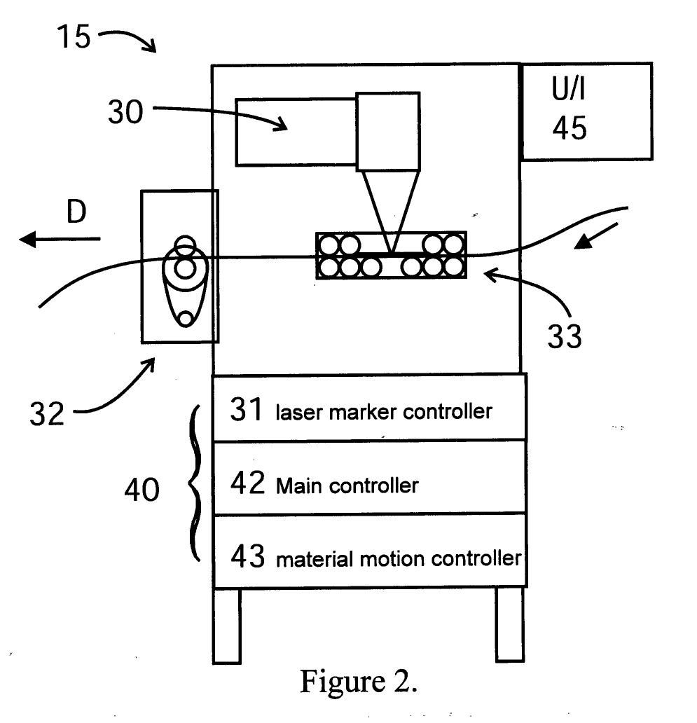

Turning to FIG. 1, an exemplary system 10 for laser micromachining a continuous material strip in-line with a stamping press has, in downstream direction D, a feedstock roll 12 for providing a continuous material strip 14—which, by way of example, may be a metal strip—a laser micromachining station 15, an accumulator 16, a stamping press 18 with an associated roll feeder 20, and a scrap roll 22. A resolver (encoder) 24 is also associated with the stamping press 18 to sense real-time press cycle position, and to provide signal to laser micromachining station. With reference to FIG. 2, the laser micromachining station 15 has a laser micromachining head 30, a motorized roll feeder 32, idler rolls 33, a controller arrangement 40, and a user interface 45. The controller arrangement includes a main controller 42 (which can be PC-based), a material motion controller 43 (which can be a programmable logic controller (PLC)), and a laser micromachining controller 31. Feeders 20 and 32 may be servo-controlled roll feeders. Idler rolls 33 are to keep the metal strip in one plane as it moves under the laser 30 within a well-controlled fixed distance, within the depth of field of the flat-field lens of the laser micromachining head.

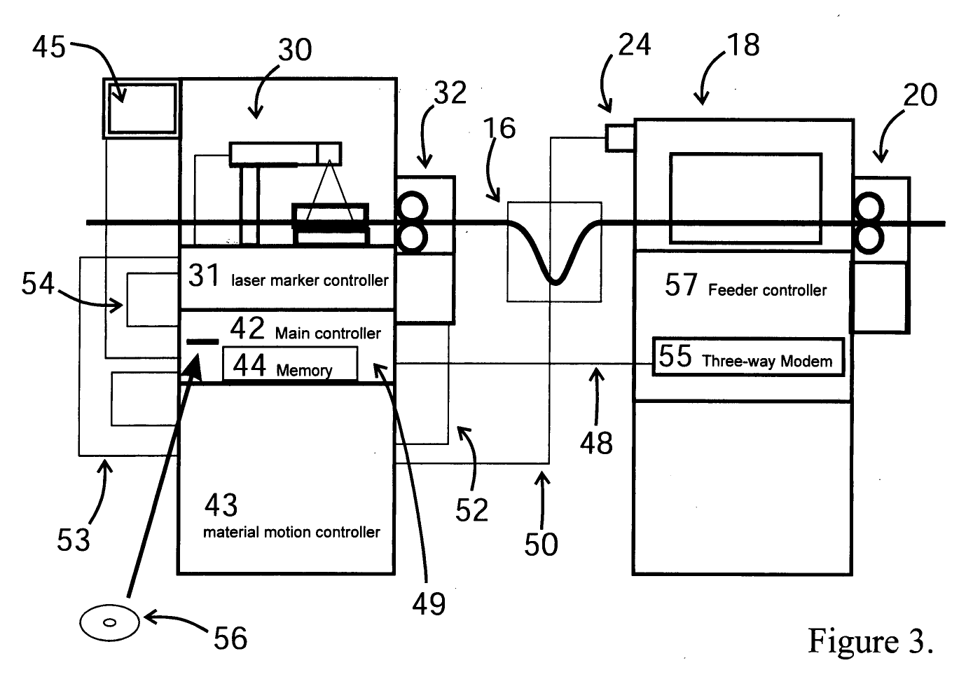

With reference to FIG. 3, the main controller 42 has a memory 44 for the storage of a laser micromachining definition file which may be loaded from standard movable media, such as compact disks 56 or other portable memory device. Memory 44 is coupled for two-way communication with the main controller 42. The main controller 42 outputs the laser micromachining definition to the laser micromachining controller 31, which in turn controls the laser micromachining process via real-time control of both laser power and laser scanner deflection of laser head 30.

The main controller 42 also handles user interface 45. The main controller 42 receives a strip progression length signal on path 48 from a three-way serial modem 55 installed in the feeder controller 57 of press feeder 20; then it confirms reception of the progression length from the press to the operator via user interface 45, and it copies the signal to the material motion controller 43. The main controller 42 also receives system state information from material motion controller 43, and it presents acknowledged state confirmation to the operator via user interface 45. The main controller 42 also has computer network connection 49.

The material motion controller 43 receives a cycle indication signal from the resolver 24 on path 50. The material motion controller 43 also has a manual motion control input for material setup through the user interface whereby a jog indication commands the material motion controller 43 to slowly and safely jog material forward or backward by any length necessary to lace the material into the press system.

The laser micromachining controller 31 also receives speed signal from the material motion controller 43 on path 53 and receive a laser trigger signal on this same path.

Laser head 30 may be any suitable scanning laser, such as a galvanometer scanning mirror combined with high-peak-power pulsed laser (1 kWatt-100 kWatt). As such, the laser marking head may comprise: laser sources, a beam expander, two galvanometers, each for rotating a mirror in one dimension, x and y, in order to selectively deflect the laser beam in a two-dimension plane orthogonal to the normal of the marking plane, for marking material based on signals from the laser micromachining controller sent to the galvanometers, and a flat-field lens to focus the laser beam into the two-dimension plane. To simplify control, the x dimension may be aligned with the feed direction, D.

To prepare system 10 for operation, the continuous metal strip 14 may be fed from feedstock roll 12, through the laser micromachining station 15, accumulator 16 and stamping press 18 to scrap roll 22. In so doing, an extra length of the strip may be provided in the accumulator 16. In this regard, the material motion controller 43 may have two modes: a ready mode and a set up mode. In set up mode, it can receive a jog command to jog the strip at the laser station 15 downstream.

In order to prepare laser micromachining station 15 for operation, memory 44 of the main controller 42 is loaded with data which defines a laser micromachining operation, to provide the laser micromachining controller with the operational parameters of the laser micromachining job. Further, an operator may input a progression length to the stamping press 18; the main controller 42 automatically receives this progression length of press via three-way serial modem 55 and associated dedicated software to validate and to relay the progression length to material motion controller 43. The operator can witness automated machine communication via communication acknowledgement indications on user interface 45. Dependent upon the characteristics of the of the material strip 14, the operator could also input an adjustment offset to accommodate for any expected (small but constant) slippage at either of the feeders 20 and/or 32.

The main controller 42 uploads the parameters for the laser micromachining operation to the laser micromachining controller 31. The laser micromachining controller 31 may then send to the main controller 42 an indication of the highest constant speed it can manage for the particular laser micromachining operation. As will become apparent, this provides the material motion controller 43 the information it needs to determine a suitable temporal speed profile for the material strip 14 through the laser micromachining station 15.

The laser micromachining station 15 is designed to undertake laser micromachining operations on-the-fly, that is, while material strip 14 is feeding downstream. However, laser operations cannot be properly undertaken with the metal strip moving at a significantly variable speed due to finite response times of various components (for example, the speed feedback signals from feeders 32 and motion controller 43). Should technology develop to allow this, it is nevertheless expected that the accuracy of laser micromachining operations will increase if these operations do not occur while the strip is moving at a variable speed. Accordingly, the material motion controller 43 controls roll feeder 32 so that the strip moves through the laser micromachining station at a constant speed (within reasonable thresholds) during laser micromachining. (The speed feedback signal from the feeder 32 allows the material motion controller to increase the accuracy of the speed control of the metal strip.)

The advantage of marking at a constant speed in a cycling system is that it can significantly increase the marking time opportunity. This advantage arises because of the finite size of the mark, as measured in the direction of motion for the material strip, and the finite size of the scanner field, for a given scanning laser head.

Assuming the marking time for a static target is To, the size of the scanner field is Do, and the size of the mark (as measured in the transverse direction to the direction, D, of material motion) is Ho, the constant speed of material (during micromachining) may be set as Vc=(Do+Ho)/(To+To*Ho/Do). Then, if the micromachining file sent to the laser micromachining controller 31 is optimized for speed (i.e., if the file is arranged so that scanning vector paths of the laser beam progress from downstream to upstream, vector nodes are minimized, and vector paths are minimized, all of which can be accomplished with suitable inputs to known optimization software), the time available for micromachining can be increased over that of laser operation on a static material strip by up to a constant equal To*Ho/Do. This extra time can provide opportunity for deeper micromachining or micromachining over a larger area, or simply reducing scanning laser power.

If the control of the micromachining process is suitably optimized, the system can start micromachining at the edge of the area to be micromachined that first presents itself in the field of the lens, and finish at the opposite edge of that area. If this is done properly, the time for micromachining can be extended, as compared to micromachining only during the time when the press is stopped, by a factor 2-3.

The material motion controller 43 can control the feeder 32 of the laser micromachining station to provide one of two possible modes of feeding: first, always feeding material strip 14 through the laser micromachining station 15 at a constant speed, and second, feeding at a lower constant speed during laser micromachining (to increase the time for laser processing) and feeding at a higher, pulsed, speed between laser micromachining events, on order to maintain the equality of the average speed of metal strip at the laser micromachining station and at the stamping press.

The second mode, which further reduced the constant speed while micromachining, and pulses the speed between laser micromachining events is more desirable as it offers maximum flexibility in optimization of the micromachining time opportunity. The system constraints defining the boundary for the micromachining time are: (i) press cycle time, (ii) maximum acceleration of the roll feeder to provide pulsed motion between micromachining events in the laser micromachining system, and (iii) actual micromachining job requirements. The optimization if the process translates in minimization of requirements for laser power and scanner speed performance, which translates directly in cost of system.

The parameters of the laser micromachining system, such as laser power, laser repetition rate, scanner marking speed, jump speed, and various programmed delays, and the demands of a given laser micromachining job, dictate the highest constant material speed that can be managed by the laser micromachining system for any given laser operation. For example, it may be that the laser micromachining operation required engraving a set of letters and characters to a depth of 1-5 microns with a 2 mm character height and the engraving extending to a height of 20 mm—the height being the dimension transverse to the feed direction, D. With this data and the parameters of the laser, the highest constant speed at which the laser can manage this engraving can be determined.

In operation, press feeder 20 indexes the portion of metal strip 14 between accumulator 16 and the press feeder 20 forwardly (i.e., in downstream direction D) and then stops this portion of the metal strip to allow a stamping operation to take place. After the stamping operation, the feeder again indexes this portion of the metal strip forwardly, and the sequence of events repeats. The sequence of indexing and stamping constitutes one cycle of the stamping press 18.

The material motion controller 43 determines the instantaneous speed profile of the material strip through the laser micromachining system. If the current average speed is below the highest constant speed that can be managed by the laser micromachining system for the needed material processing operation (as determined at the outset by the laser micromachining controller), then the material motion controller can simply set feeder 32 to constant feed velocity for the metal strip 14 through the laser micromachining station at the current average speed of the metal strip through the stamping press.

If the current average speed is above the highest constant speed that can be managed by the laser micromachining system for the needed material processing operation (as determined at the outset by the laser micromachining controller), then the material motion controller will minimize constant velocity of feeder 32 during laser processing, and execute pulsed motion of the metal strip 14 through the laser micromachining station between laser processing event so as to keep the average speed of the metal strip in the laser micromachining system equal to the speed of the metal strip in the stamping press.

A stamping press, while stamping, causes significant vibrations. These vibrations can negatively impact on the precision of the laser micromachining operation. To avoid problems with such vibrations, the material motion controller 43 controls the timing of the laser processing event so as to undertake the laser micromachining operation while the stamping press is at the quietest part of its cycle, i.e. while material strip is being indexed through the stamping press. Thus, the laser is controlled to operate out-of-phase with the stamping press or, put another way, when the laser is micromachining, the stamping press is not stamping.

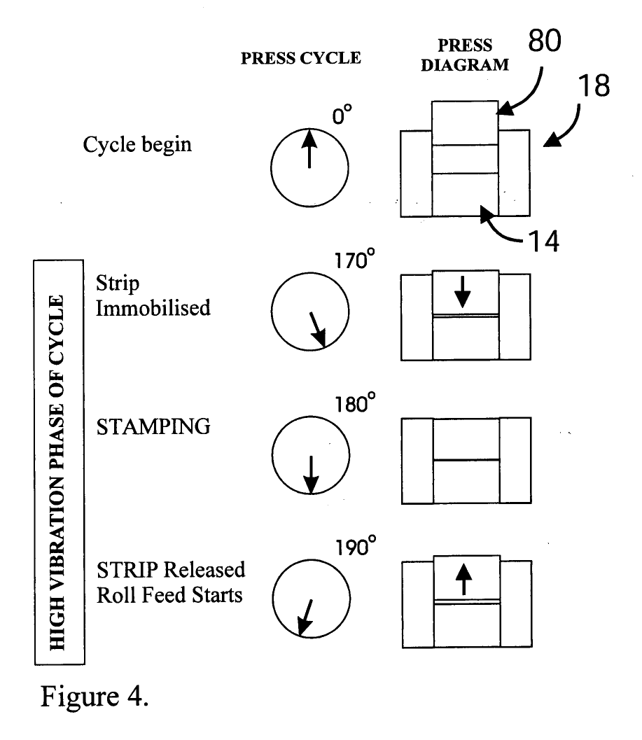

More precisely, as illustrated in FIG. 4, taking 0° as the part of the press cycle when the ram 80 of the press is at top dead center and 180° when the ram is at bottom dead centre, the high vibration portion of the cycle of the press 18 may be considered that part of the cycle when the ram is between 170° and 190°. It may also accord to the part of the press cycle when the metal strip is held immobile in the press. Accordingly, the material motion controller 43 sends the laser processing trigger signal to the laser controller 31 at the most opportune time so that it does not operate during the actual stamping portion of the press cycle. This timing control is made possible by the signal provided by the resolver (rotary encoder) 24 to the material motion controller. More specifically, the resolver may be adjacent the cam shaft of the ram of the stamping press and a sensor of the resolver may be attached to the cam shaft. In consequence, the resolver can produce a signal to the material motion controller 43 which is indicative of the position of the ram of the stamping press, and hence an indication of the current part of the cycle of the stamping press.

The instantaneous speed of the strip through the stamping press varies between zero (during stamping) and a peak speed (during indexing). The length of metal strip in the accumulator accommodates differences between the instantaneous speed of the strip through the stamping press and the constant speed through the laser micromachining station.

If the current average speed of the stamping press is above the highest constant speed at which the laser micromachining operation could be completed (i.e., the laser operation could not be completed were the material strip to move steadily with a constant speed equal to the cycle-average speed of material in the stamping press), then the material motion controller will command material feed through station 15 with the dual velocities described above. More specifically, the material motion controller uses a lower constant speed optimized for motion of material strip during the laser micromachining operation, and a faster pulsed speed motion of the material strip between laser micromachining events such that the average speed through the laser micromachining station equals the average speed of the strip through the stamping press.

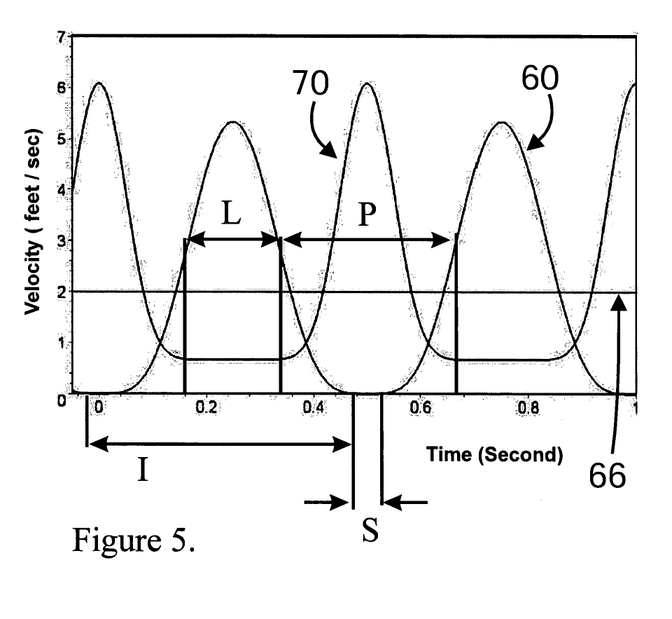

FIG. 5 illustrates these two modes of operation. Turning to FIG. 5, the speed profile 60 of the metal strip through the stamping press has a pulsed indexing portion I and a zero-velocity stamping operation portion S. Line 66 shows the average velocity profile of the material strip through the combined system of the laser micromachining station and the stamping press. In one mode of operation suitable for some laser processing jobs, the material motion through the laser micromachining station is simply equal to average velocity profile of the material strip through the system.

Curve 70 shows the variable speed profile for the strip through the laser micromachining station with a constant speed section L during which the laser micromachining operation occurs and a pulsed higher speed section P between laser micromachining events. Moving the material at a slower speed during laser micromachining provides a number of advantages: (i) it allows for a longer time for laser micromachining to thereby lower the throughput requirements for the laser micromachining process, (ii) it allows a smaller optical field for the laser micromachining, hence allowing a correspondingly smaller laser spot size; and (iii) the smaller laser spot size translates into higher peak intensities, hence reducing overall laser peak power.

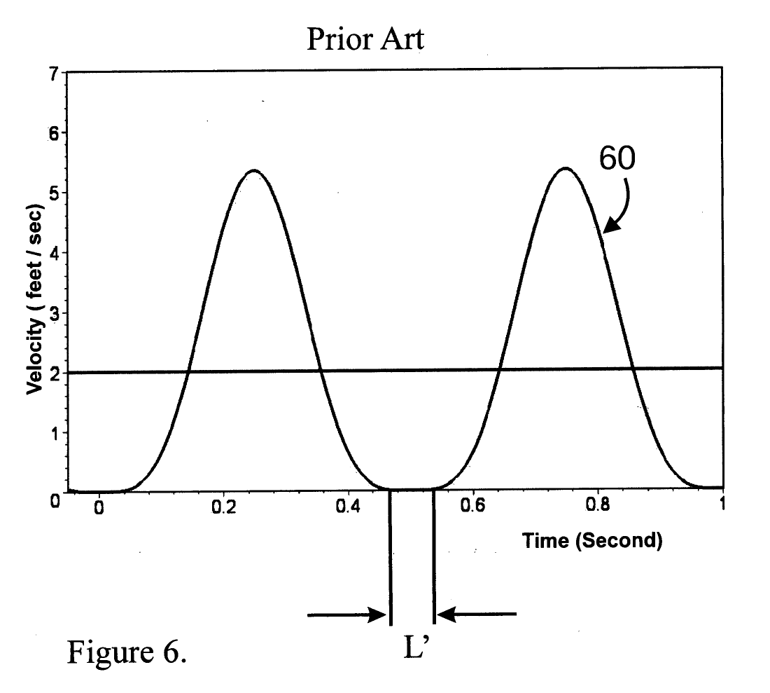

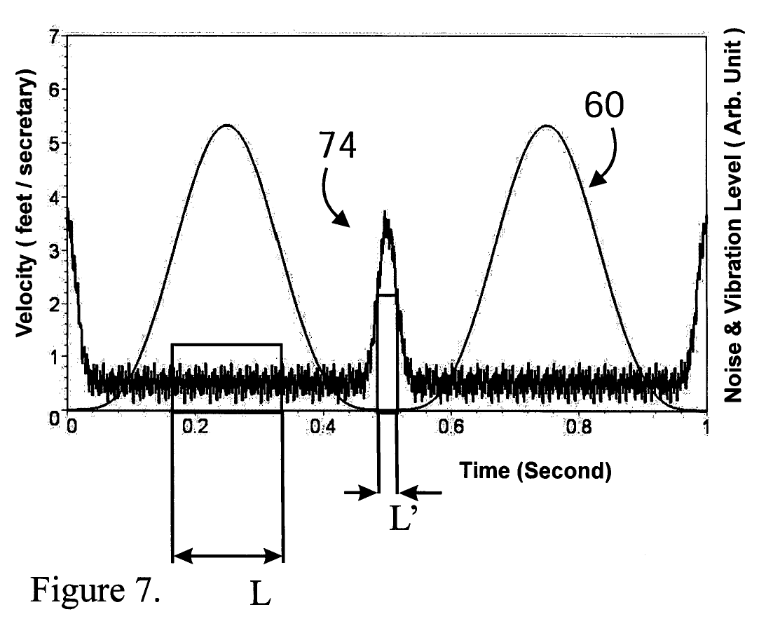

Indeed, as illustrated in FIGS. 6 and 7, compared with a laser micromachining system where the laser operates when the material strip is stopped in the press—i.e., during the interval L′—the time for laser micromachining can be multiplied by a factor of three to five times.

In this regard, FIG. 7 indicates at 74 the magnitude and time duration of vibrations from stamping; such vibration while micromachining can be quite detrimental to quality of laser processing and long-term system reliability, considering the additional strain imposed by the vibration.

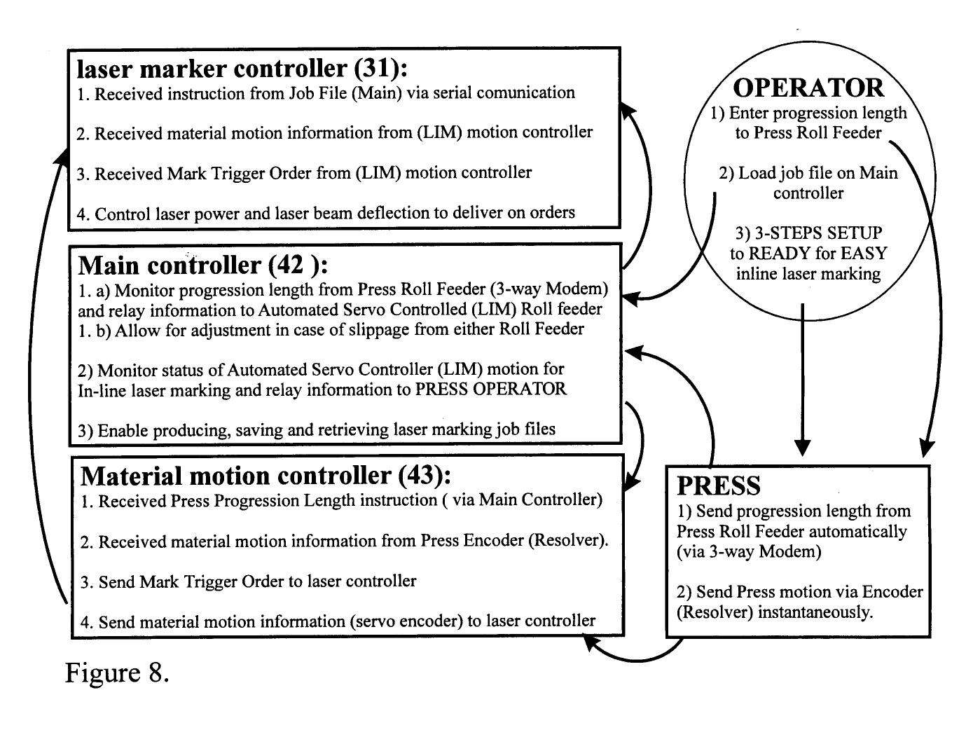

As illustrated in FIG. 8, with the exemplary controller arrangement 40, the main controller 42 can enable an operator to load a job file for laser marking, send the job order to the laser micromachining controller 31, monitor for a change in the progression length from the press feeder 20, and monitor for changes in the state (ready versus set up) of the material motion controller 43. The material motion controller can ensure a slave relationship to the press ram via the press resolver, that is, it can ensure that laser processing occurs out-of-phase with stamping by sending a trigger signal to the laser micromachining controller 31 at an appropriate time. Of course, the main controller 42 and material motion controller 43 could be provided by a single controller. Further, this single controller could also undertake the functions of the laser micromachining controller 31 thereby obviating the need for a separate laser micromachining controller.

If less laser micromachining accuracy is needed, it may be possible to continue a laser micromachining operation during a stamping operation. In such instance, the speed profile constraints for the strip through the laser micromachining station may be somewhat relaxed. Consequently, there will be more instances where a perpetual constant speed profile for the strip through the laser micromachining station will be possible.

In arrangements where the metal parts are not sheared from the metal strip at the downstream end of the stamping press, the laser micromachining station can be positioned downstream of the stamping press. In such instance, the accumulator is re-positioned at the downstream end of the stamping press so as to remain between the stamping press and the laser micromachining station.

While the exemplary embodiment has a single accumulator, alternatively, additional accumulators may be provided: thus, there may be an accumulator not only between the laser station and press but also at other side of each of the press and laser station.

It will be apparent that the described system may be used for a wide variety of laser micromachining operations such as laser marking, laser cutting, laser milling, or laser ablation.

The described arrangements provide a number of advantages. For example, if laser micromachining occurred when the metal strip was stopped in the stamping press, the short time available for micromachining would require a more powerful, and therefore more expensive, laser. By laser processing on-the-fly, more time is available for micromachining; consequently, this allows use of a much less powerful scanning laser, hence there is a significant reduction of system cost. Moreover, if the speed of the strip in the laser micromachining station is pulsed at higher speed while the laser is not irradiating, the constant material speed during micromachining can be reduced, hence further enhancing the advantage. Additionally, by laser irradiating out of phase with the stamping press, the quality of the laser operations can be improved.

Other modifications will be apparent to those skilled in the art and, therefore, the invention is defined in the claims.

1. A method for processing a continuous material strip, comprising:
indexing a first portion of said continuous material strip through a stamping press;
cycling said stamping press so as to undertake a stamping operation on a section of said material strip during each cycle of said stamping press;
accumulating a length of said continuous strip in an accumulator either upstream or downstream of said stamping press;
continuously feeding a second portion of said strip at a non-zero speed through a laser micromachining station positioned such that said accumulator is between said stamping press and said laser micromachining station;
controlling said speed of said second portion of said strip so that said speed is constant for at least a portion of each cycle of said stamping press and so that an average speed of said first portion of said strip through said stamping press is equal to an average speed of said second portion of said strip through said laser micromachining station; and
undertaking a laser micromachining operation on said second portion of said strip while said speed of said second portion of said strip is constant.

2. The method of claim 1 wherein said speed of said second portion of said strip is constant throughout each cycle of said stamping press.

3. The method of claim 1 wherein said speed of said second portion of said strip is constant for a portion of each cycle of said stamping press and is pulsed above said constant speed for another portion of each cycle of said stamping press.

4. The method of claim 1 wherein each said laser micromachining operation is undertaken during a portion of a cycle of said stamping press when said material strip is not in the process of being stamped.

5. The method of claim 4 wherein said laser micromachining operation is undertaken at a time that is medially between two consecutive times during which said material strip is being stamped.

6. The method of claim 1 wherein said laser micromachining operation is one of a marking operation, an engraving operation, and a machining operation.

7. The method of claim 6 wherein said stamping operation is one of a material deforming operation and a material shearing operation.

8. The method of claim 1 wherein said accumulator is upstream of said stamping press and said stamping press shears parts from said material strip.

9. The method of claim 1 wherein said laser micromachining station has a scanning laser and further comprising scanning said laser on said second portion of said material strip during each said laser micromachining operation.

10. A laser micromachining system for use in-line with a stamping press operating on a continuous material strip comprising:
a scanning laser;
a feeder for feeding said material strip past said scanning laser;
control means input by a cycle indicating signal indicating each cycle of said stamping press and a signal indicating material progression through said press and outputting to a control input of said feeder and an input of said scanning laser for:
determining an average speed of said material strip through said stamping press;
determining a speed profile for said material strip past said scanning laser based on said average speed;
controlling said feeder and said laser based on said speed profile.

11. The laser micromachining system of claim 10 further comprising a resolver for generating said cycle indicating signal.

12. The laser micromachining system of claim 11 further comprising an accumulator for accumulating a length of said material strip at one of an upstream side or downstream side of said scanning laser.

13. The laser micromachining system of claim 10 wherein said scanning laser is a galvanometer-based scanning laser.

14. The laser micromachining system of claim 10 wherein said feeder has a feeder speed signal output and wherein said controller is input by said feeder speed signal and wherein said controller is also for adjusting a control signal to said feeder based on said feeder speed signal.

15. The laser micromachining system of claim 10 wherein said control means has a memory for containing information on a laser micromachining operation to be performed by said laser and wherein said control means also controls said laser based on laser micromachining operation information.

16. The laser micromachining system of claim 10 wherein said controller in determining a speed profile for said material strip past said scanning laser determines a speed profile with a constant speed portion and a variable speed portion.

17. The laser micromachining system of claim 10 wherein said laser is one of a Q-switched laser, a mode-locked laser, a pulsed fiber-laser, and any other high-peak pulsed laser with peak optical power between 2-50 kWatt, and average optical power between 5-100 watt and laser emission wavelength between 254 nm and 15 microns.

18. The laser micromachining system of claim 16 wherein said variable speed portion has speeds higher than a speed of said constant speed portion.

19. An in-line continuous material strip stamping and laser micromachining system comprising:
a stamping press for indexing downstream and stamping a first portion of a continuous material strip during each of consecutive cycles;
an accumulator either upstream or downstream of said stamping press for accumulating a length of said continuous strip;
a laser micromachining station for undertaking a laser micromachining operation on said second portion of said strip, said laser micromachining station positioned such that said accumulator is between said stamping press and said laser micromachining station;
control means for controlling said speed of said second portion of said strip so that said speed is constant for at least a portion of each cycle of said stamping press and so that an average speed of said first portion of said strip through said stamping press is equal to an average speed of a second portion of said strip through said laser micromachining station and for triggering said laser micromachining station to undertake said laser micromachining operation while said speed of said second portion of said strip is constant.
